(19) United States
(12) Patent Application Publication
(10) Pub. No.: US 2017/0078210 A1
(43) Pub. Date: Mar. 16, 2017

(54) Controlling Packet Transmission In Software Defined Network

(71) Applicant: HANGZHOU H3C TECHNOLOGIES CO., LTD., Zhejiang (CN)

(72) Inventors: Wei WANG, Beijing (CN); Hai WANG, Beijing (CN)

(21) Appl. No.: 15/309,079

(22) PCT Filed: Apr. 30, 2015
(86) PCT No.: PCT/CN2015/077996

§ 371 Date: Nov. 4, 2016

(30) Foreign Application Priority Data
May 4, 2014 (CN) 201410184752.8

(51) Int. Cl. H04L 12/825; H04L 12/26; H04L 12/823; H04L 12/751

(52) U.S. Cl. CPC H04L 47/25; H04L 45/02; H04L 43/0882; H04L 43/16; H04L 47/32; H04L 2212/00

(57) ABSTRACT

A controller acquires information of a forwarding device in the SDN which is connected with an external network and/or a terminal device. The controller calculates a maximum transmission rate for the forwarding device to transmit a SDN packet to the controller according to the acquired information of the forwarding device. The controller sends the maximum transmission rate to the forwarding device, so that the forwarding device controls transmitting a SDN packet to the controller according to the maximum transmission rate.

### BACKGROUND

In a Software Defined Network (SDN), a control plane and a forwarding plane are separated, so that the control plane and the forwarding plane are hosted in separate devices. Thus, the control plane may be delivered by an operating system which is independent of the forwarding plane, and features of the SDN may be easily customized according to the needs of the network.

OpenFlow is one example of a SDN standard that is gaining increasing acceptance in the market. OpenFlow defines a SDN architecture and a communication interface between a control layer and a data forwarding layer. OpenFlow allows a controller to directly access and operate the forwarding plane of network devices. These network devices may be physical or virtual. The teachings of the present disclosure may be applied to OpenFlow and to other SDN standards.

### BRIEF DESCRIPTION OF THE DRAWINGS

FIG. 1 is a flow diagram illustrating a method for controlling packet transmission in SDN according to an example of the present disclosure.

FIG. 2 is a flow diagram illustrating a method for acquiring information of a forwarding device in the SDN which is connected with an external network and/or a terminal device according to an example of the present disclosure.

FIG. 3 is a flow diagram illustrating a method for determining which forwarding device in the SDN is connected with the external network and/or the terminal device according to another example of the present disclosure.

FIG. 4 is a flow diagram illustrating a method for acquiring a network topology structure between forwarding devices in a SDN according to an example of the present disclosure.

FIG. 5 is a schematic diagram illustrating a SDN networking according to an example of the present disclosure.

FIG. 6 is a flow diagram illustrating a method for controlling packet transmission in SDN according to another example of the present disclosure.

FIG. 7 is a schematic diagram illustrating a structure of an apparatus for controlling packet transmission in SDN according to an example of the present disclosure.

FIG. 8 is a schematic diagram illustrating a structure of a SDN controller according to an example of the present disclosure.

### DETAILED DESCRIPTION

In an OpenFlow network, for any packet which is not matched with a flow table, the forwarding device sends such packet to the SDN controller for further processing, so that the processing burden of the SDN controller becomes heavy. The processing burden of the SDN controller becomes heavier when the SDN is attacked. Accordingly, the present disclosure proposes a technique of controlling packet transmission in SDN.

Before describing this in further detail, in order to improve understanding, some terms used in the present disclosure will first be explained as follows.

Packet-in packet: a SDN forwarding device encapsulates a received packet in a packet-in packet, and sends the packet-in packet to a SDN controller through a SDN control link. An in-port through which the SDN forwarding device receives the packet is indicated in the packet-in packet.

Packet-out packet: a SDN controller encapsulates a packet in a packet-out packet, sends the packet-out packet to a SDN forwarding device through a SDN control link, and informs the SDN forwarding device through the packet-out packet how to process the packets encapsulated in the packet-out packet.

Forwarding device: a device with a forwarding plane for forwarding packets, for example, a SDN switch or virtual switch, or a router, etc.

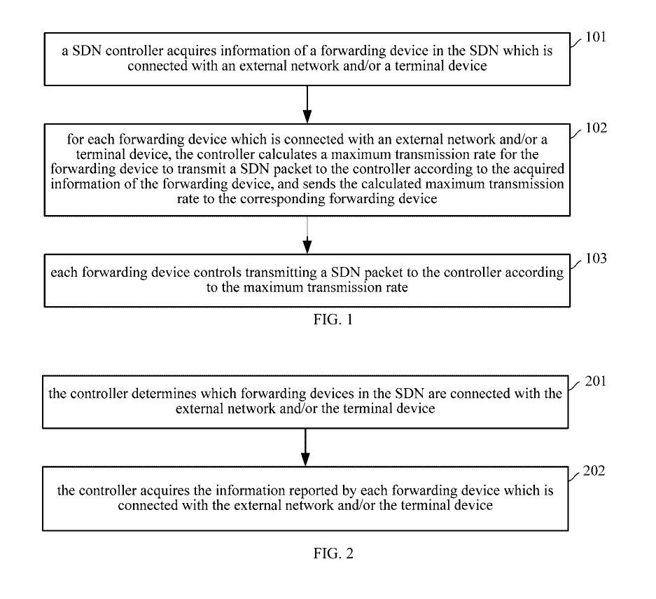

FIG. 1 is a flow diagram illustrating a method for controlling packet transmission in SDN according to an example of the present disclosure. As shown in FIG. 1, the method may include the following procedures.

At block 101, a SDN controller acquires information of a forwarding device in the SDN which is connected with an external network and/or a terminal device. An “external network” means a network outside of the SDN. The terminal device may for example be a personal computer (PC), notebook computer, other client device or a server etc.

Because an edge device will be the first device in the network to suffer from network attacks, a SDN forwarding device which is connected with an external network and/or a terminal device is regarded as an edge device. At block 101, the SDN controller acquires information of a forwarding device which is connected with an external network and/or a terminal device.

At block 102, for each forwarding device which is connected with an external network and/or a terminal device, the controller calculates a maximum transmission rate for the forwarding device to transmit a SDN packet to the controller according to the acquired information of the forwarding device, and sends the calculated maximum transmission rate to the corresponding forwarding device.

At block 103, each forwarding device controls transmitting a SDN packet to the controller according to the maximum transmission rate.

In this way, the number of packets transmitted from the forwarding device to the controller may be controlled, and the heavy burden may be alleviated for the SDN controller.

Example implementations of block 101 of FIG. 1 will now be described in more detail, by way of example.

FIG. 2 is a flow diagram illustrating a method for acquiring information of a forwarding device in the SDN which is connected with an external network and/or a terminal device and is a non-limiting example of one way in which block 101 of FIG. 1 may be implemented. As shown in FIG. 2, the method may include the following procedures.

At block 201, the controller determines which forwarding devices in the SDN are connected with the external network and/or the terminal device.

At block 202, the controller acquires the information reported by each forwarding device which is connected with the external network and/or the terminal device. For example, the information includes a type of the forwarding device, and/or a type of a device which is connected with the forwarding device, and/or a bandwidth of a port through which the forwarding device accesses a control layer in the SDN.

In an example, the type of the forwarding device may represent the packet processing capability of the forwarding device. The type of the device which is connected with the forwarding device may refer to “external network” or “terminal device”.

In an example, SDN may be separated into a control layer and a data forwarding layer. The port through which the forwarding device accesses the control layer may include the port through which the forwarding device is connected with the controller directly or indirectly.

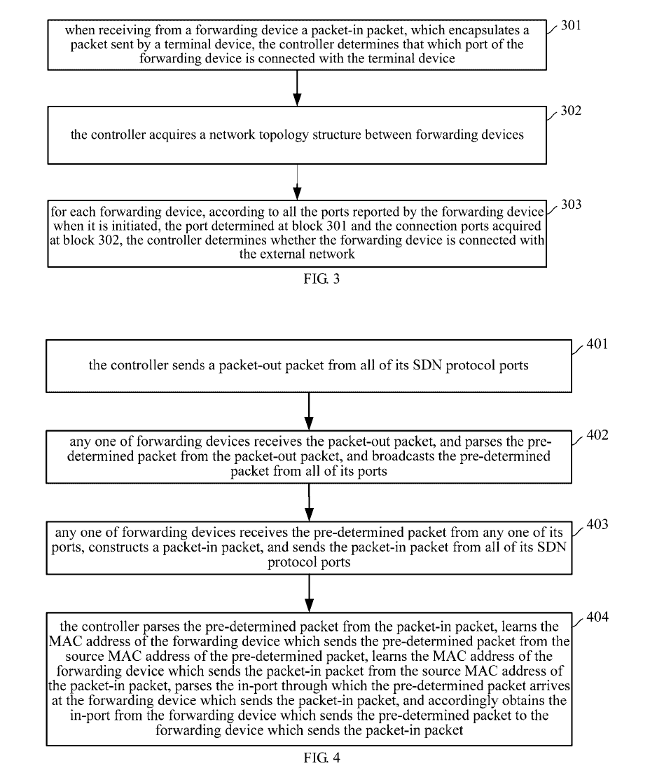

FIG. 3 is a flow diagram illustrating a method for determining which forwarding device in the SDN is connected with the external network and/or the terminal device and is a non-limiting example of one way in which block 201 of FIG. 2 may be implemented. As shown in FIG. 3, the method may include the following procedures.

At block 301, when receiving from a forwarding device a packet-in packet, which encapsulates a packet sent by a terminal device, the controller determines that which port of the forwarding device is connected with the terminal device.

For example, when the terminal device goes online, the terminal device may automatically send a free Address Resolution Protocol (ARP) request packet which carries its Internet Protocol (IP) address. When the ARP request packet arrives at a forwarding device which is connected with the terminal device, the forwarding device may encapsulate the ARP request packet into a packet-in packet, and at the same time encapsulate the in-port through which the forwarding device receives the ARP request packet into the packet-in packet, and sends the packet-in packet to the controller. As a result, the controller can determine from the packet-in packet that which port of the forwarding device is connected with the terminal device.

At block 302, the controller acquires a network topology structure between forwarding devices, i.e., acquires connection ports between each pair of forwarding devices.

At block 303, for each forwarding device, according to all the ports reported by the forwarding device when it is initiated, the port determined at block 301 and the connection ports acquired at block 302, the controller determines whether the forwarding device is connected with the external network.

Each forwarding device in the SDN reports all its ports to the controller when the forwarding device is initiated.

In one example, when it is determined at block 301 that the port through which the forwarding device is connected with a terminal device is available, if there are no ports remained when removing the port determined at block 301 and the connection ports acquired at block 302 from all the ports reported by the forwarding device, the controller determines that the forwarding device is not connected with the external network, otherwise, determines that the forwarding device is connected with the external network.

In another example, when it is determined at block 301 that the port through which the forwarding device is connected with a terminal device is not available, if there are no ports remained when removing the connection ports acquired at block 302 from all the ports reported by the forwarding device, the controller determines that the forwarding device is not connected with the external network, otherwise, determines that the forwarding device is connected with the external network.

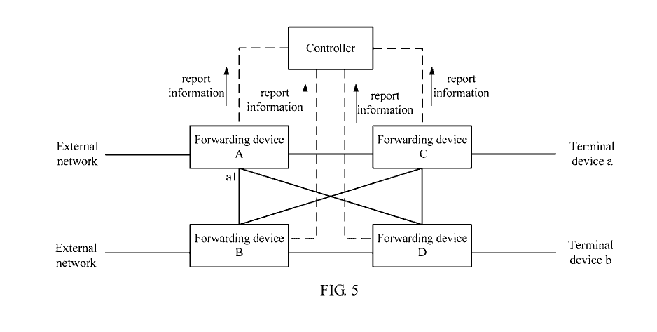

FIG. 4 is a flow diagram illustrating a method for acquiring a network topology structure between forwarding devices in a SDN and is a non-limiting example of one way in which block 302 of FIG. 3 may be carried out. As shown in FIG. 4, the method may include the following procedures.

At block 401, the controller sends a packet-out packet from all of its SDN ports, the packet-out packet carrying a pre-determined packet and a corresponding action of “broadcasting in a Virtual Local Area Network (VLAN) of the data forwarding network in SDN”.

The pre-determined packet may be any packet which is able to be sent by the forwarding device to the controller. For example, the pre-determined packet may be a Link Layer Discovery Protocol (LLDP) packet.

At block 402, any one of forwarding devices receives the packet-out packet, parses the pre-determined packet from the packet-out packet, and according to the action carried in the packet-out packet: “broadcasting in a VLAN of the data forwarding network in SDN”, broadcasts the pre-determined packet from all of its ports.

At block 403, any one of forwarding devices receives the pre-determined packet from any one of its ports, constructs a packet-in packet, and sends the packet-in packet from all of its SDN ports. The packet-in packet encapsulates the pre-determined packet, and carries an in-port through which the forwarding device receives the pre-determined packet. A source Media Access Control (MAC) address of the packet-in packet is the MAC address of the forwarding device, and a destination MAC address of the packet-in packet is the MAC address of the controller.

The controller may distribute to each forwarding device a flow table entry in advance, i.e., when receiving a pre-determined packet, the action is “sending to the controller”. Thus, when a pre-determined packet is received, the forwarding device matches the pre-determined packet with the flow table entry, so that a packet-in packet is constructed and sent to the controller. Or, the flow table entry may not be distributed, since according to the SDN protocol, the forwarding device sends any unknown packets to the controller.

At block 404, when the controller receives from any one of its SDN ports a packet-in packet which is sent from any one of forwarding devices, the controller parses the pre-determined packet from the packet-in packet, learns the MAC address of the forwarding device which sends the pre-determined packet from the source MAC address of the pre-determined packet, learns the MAC address of the forwarding device which sends the packet-in packet from the source MAC address of the packet-in packet, parses the in-port through which the pre-determined packet arrives at the forwarding device which sends the packet-in packet, and accordingly obtains the in-port from the forwarding device which sends the pre-determined packet to the forwarding device which sends the packet-in packet.

As a result, the controller may acquire connection ports between each pair of connected forwarding devices, i.e., acquire a network topology structure between forwarding devices.

In one example, blocks 401-402 may also be replaced by: any one of forwarding devices automatically broadcasts a pre-determined packet from all of its ports when the forwarding device is initiated. Then, by performing blocks 403-404, the controller acquires connection ports between each pair of connected forwarding devices, i.e., acquires a network topology structure between forwarding devices. The pre-determined packet may be a LLDP packet generated by the forwarding device.

FIG. 5 is a schematic diagram illustrating a SDN networking according to an example of the present disclosure. As shown in FIG. 5, assume the pre-determined packet is a LLDP packet. When forwarding device A receives from port al a LLDP packet sent by forwarding device B, the forwarding device A encapsulates the LLDP packet in a packet-in packet, and also encapsulates the port al in the packet-in packet. When the packet-in packet arrives the controller, the controller parses the LLDP packet from the packet-in packet, learns from the source MAC address of the LLDP packet that the forwarding device B sends the LLDP packet, learns from the source MAC address of the packet-in packet that the forwarding device A sends the packet-in packet, and parses from the packet-in packet that the in-port al through which the forwarding device A receives the LLDP packet, accordingly learns that the in-port from the forwarding device B to the forwarding device A is the port al.

Because each forwarding device may broadcast a LLDP packet to its neighbor forwarding devices, the controller is able to acquire connection ports between each pair of connected forwarding devices, i.e., acquire a network topology structure between forwarding devices.

In an example, the above-described pre-determined packet may also carry an out-port when it is sent from a forwarding device. Thus, the connection ports between each pair of connected forwarding devices acquired by the controller include an out-port in one forwarding device and an in-port in another connected forwarding device.

In one example, blocks 302-303 may also be replaced by: when deploying the SDN, the network manager may configure in the controller an identifier and connection ports of a forwarding device which is connected with the external network, so that the controller may directly determine which port of which forwarding device in the SDN is connected with the external network.

In an example of one way in which block 102 of FIG. 1 may be implemented, for any one of forwarding devices, according to the type of the forwarding device, and/or the type of the device which is connected with the forwarding device, and/or the bandwidth of a SDN port which represents the packet processing capability of the forwarding device, the controller allocates a calculation factor when calculating the maximum transmission rate for the forwarding device, and according to the calculation factor, calculates a maximum transmission rate for each forwarding device to transmit a SDN packet to the controller.

Further, after the controller sends the calculated maximum transmission rate to the corresponding forwarding device in block 102, the controller may also monitor its state of processing packets in terms of a packet processing indicator. When it determines that the packet processing indicator is beyond a pre-determined alarm value, it may discard some SDN packets sent by the forwarding device according to a pre-determined strategy.

In an example, discarding some SDN packets sent by the forwarding device according to a pre-determined strategy may include:

for each forwarding device, calculating a SDN packet transmission rate by dividing a real-time transmission rate by the bandwidth of the port through which the forwarding device accesses a control layer in the SDN, by ranking the calculated SDN packet transmission rates in a descending order, determining the forwarding devices from which the received packets will be discarded, discarding the packets sent by the determined forwarding devices successively, until the packet processing indicator of the controller reaches a normal value.

The packet processing indicator may be a Central Processing Unit (CPU) occupancy rate, and/or whether the SDN packets overflow from a buffer.

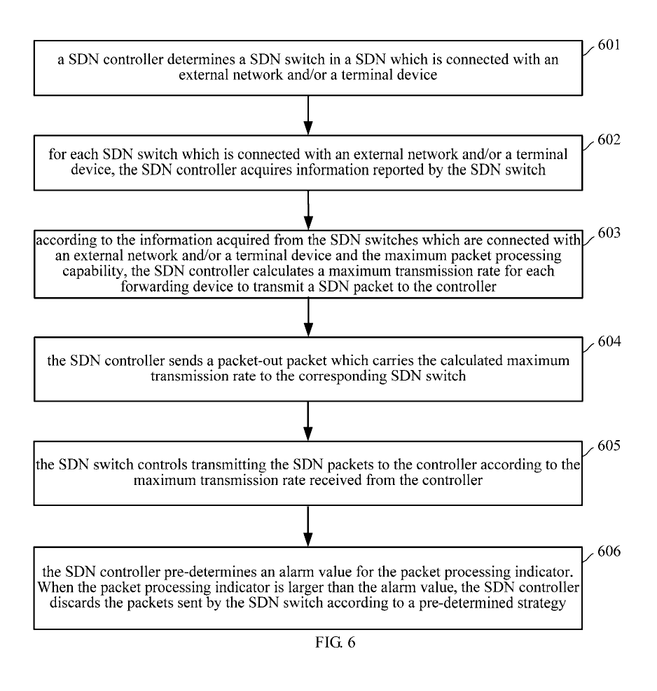

FIG. 6 is a flow diagram illustrating a method for controlling packet transmission in SDN according to another example of the present disclosure. In an example, an OpenFlow protocol may be operated in the SDN. As shown in FIG. 6, the method may include the following procedures.

At block 601, a SDN controller determines a SDN switch in a SDN which is connected with an external network and/or a terminal device.

At block 602, for each SDN switch which is connected with an external network and/or a terminal device, the SDN controller acquires information reported by the SDN switch.

As shown in FIG. 5, SDN switches (forwarding devices) A to D report the corresponding information to the controller. The above-described information may include a type of the SDN switch, a type of a device which is connected with the SDN switch, and a bandwidth of a SDN port through which the SDN switch accesses a control layer in the SDN.

As shown in FIG. 5, the forwarding devices A to D are SDN switches, the information acquired from the SDN switches which are connected with an external network and/or a terminal device are shown in Table 1.

TABLE 1
Information acquired from the SDN switches which are connected
with an external network and/or a terminal device

| SDN switch | | Type of the device | |
|---|---|---|---|
| (forwarding | Type of the | which is connected | Bandwidth |
| device) | SDN switch | with the SDN switch | of a SDN port |
| A | 12508 | External network | 1 G |
| B | 12508 | External network | 1 G |
| C | 5820 | Terminal device | 100M |
| D | 5820 | Terminal device | 100M |

At block 603, according to the information acquired from the SDN switches which are connected with an external network and/or a terminal device and the maximum packet processing capability, the SDN controller calculates a maximum transmission rate for each forwarding device to transmit a SDN packet to the controller.

The maximum packet processing capability of the SDN controller may be related with the CPU, memory, etc.

In an example, according to the packet processing capability of each SDN switch, a calculation factor for calculating the maximum transmission rate may be configured in the controller in advance, and, so that the controller may calculate a maximum transmission rate for each SDN switch according to the calculation factor.

For example, the calculation factor may be configured respectively according to the type of the forwarding device, the type of the device which is connected with the forwarding device, and the bandwidth of the port through which the forwarding device accesses a control layer in the SDN. Then, three calculation factors are obtained, and the sum of these three calculation factors are regarded as a total calculation factor for each SDN switch.

In an example, one of these three calculation factors may be regarded as a total calculation factor for the corresponding SDN switch, or the sum of any two of these three calculation factors may be regarded as a total calculation factor for the corresponding SDN switch.

If the packet processing capability represented by the type of the SDN switch is higher, the calculation factor configured according to the type of the SDN switch may be greater; If the packet processing capability represented by the type of the device which is connected with the SDN switch is higher, the calculation factor configured according to the type of the connected device may be greater, for example, compared with the terminal device, the packet processing capability represented by the external network may be higher; and if the bandwidth of a SDN port is higher, the calculation factor configured according to the bandwidth may be greater.

With reference to FIG. 5, the calculation factors configured respectively according to the type of the SDN switch, the type of the device which is connected with the SDN switch, and the bandwidth of a SDN port are shown in Table 2 within the brackets, wherein the total calculation factor allocated for each SDN switch is the sum of three calculation factors.

TABLE 2
Calculation factors allocated for each SDN switch

| | | Type of the | | |
|---|---|---|---|---|
| SDN switch | | device which is | | Total |
| (forwarding | Type of the | connected with | Bandwidth | calculation |
| device) | SDN switch | the SDN switch | of a SDN port | factor |
| A | 12508 (10) | External | 1 G (10) | 10 + 10 + 10 = 30 |
| | | network (10) | | |
| B | 12508 (10) | External | 1 G (10) | 10 + 10 + 10 = 30 |
| | | network (10) | | |
| C | 5820 (3) | Terminal | 100M (1) | 3 + 3 + 1 = 7 |
| | | device (3) | | |
| D | 5820 (3) | Terminal | 100M (1) | 3 + 3 + 1 = 7 |
| | | device (3) | | |

Assume the maximum packet processing capability of the SDN controller is 1G, and a pre-determined percentage of the maximum packet processing capability is used for controlling the packets sent by the SDN switch. The pre-determined percentage may be adjusted adaptively, for example, 90%, or beyond 100%. The maximum transmission rate may be calculated by: the maximum packet processing capability of the SDN controller*the pre-determined percentage/the sum of all total calculation factors*total calculation factor of each SDN switch.

Table 3 shows the maximum transmission rate calculated for each forwarding device to transmit SDN packets to the controller according to the total calculation factor as shown in Table 2, wherein the pre-determined percentage is 90%.

TABLE 3
Maximum transmission rate for each SDN switch
to transmit SDN packets to the controller

| SDN switch | |
|---|---|
| (forwarding | |
| device) | Maximum transmission rate |
| A | (1000M*0.9/(30 + 30 + 7 + 7))*30 = 365M |
| B | (1000M*0.9/(30 + 30 + 7 + 7))*30 = 365M |
| C | (1000M*0.9/(30 + 30 + 7 + 7))*7 = 85M |
| D | (1000M*0.9/(30 + 30 + 7 + 7))*7 = 85M |

At block 604, the SDN controller sends a packet-out packet which carries the calculated maximum transmission rate to the corresponding SDN switch.

At block 605, the SDN switch controls transmitting the SDN packets to the controller according to the maximum transmission rate received from the controller.

In an example, according to the maximum transmission rate received from the controller, the SDN switch configures the maximum transmission rate of its SDN port. When the transmission rate of the SDN port is beyond the maximum transmission rate, the SDN switch discards packets. The maximum transmission rate of its SDN port is not larger than the maximum transmission rate received from the controller.

At block 606, the SDN controller pre-determines an alarm value for the packet processing indicator. When the packet processing indicator is larger than the alarm value, the SDN controller discards the packets sent by the SDN switch according to a pre-determined strategy.

In an example, the packet processing indicator may be a CPU occupancy rate, and/or whether the SDN packets overflow. For example, when the CPU occupancy rate is larger than a pre-determined maximum occupancy rate, and/or the SDN packets overflow from the buffer, the SDN controller discards the packets sent by the SDN switch according to a pre-determined strategy.

In one example, the pre-determined strategy may include: calculating a SDN packet transmission rate by dividing a real-time transmission rate by a bandwidth of an port through which the SDN switch accesses a control layer, by ranking the calculated SDN packet transmission rates in a descending order, discarding the packets sent by the corresponding switches successively, until the packet processing indicator of the SDN controller reaches a normal value.

In this case, the real-time transmission rate of SDN packets for each SDN switch is maintained in the controller, as shown in Table 4.

TABLE 4
Real-time transmission rate of SDN packets for
each SDN switch maintained in the controller

| SDN switch | | Real-time |
|---|---|---|
| (forwarding | Bandwidth | transmission rate of |
| device) | of a SDN port | SDN packets |
| A | 1 G | 300M |
| B | 1 G | 200M |
| C | 100M | 80M |
| D | 100M | 85M |

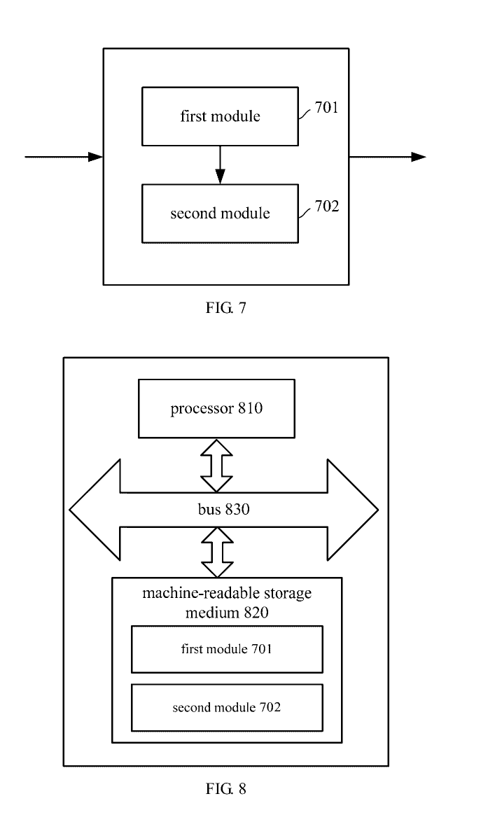

FIG. 7 is a schematic diagram illustrating a structure of an apparatus for controlling packet transmission in SDN according to an example of the present disclosure. As shown in FIG. 7, the apparatus includes a first module 701 and a second module 702.

The first module 701 acquires information of a forwarding device in the SDN which is connected with an external network and/or a terminal device.

The second module 702 calculates a maximum transmission rate for the forwarding device to transmit a SDN packet to the controller according to the information of the forwarding device acquired by the first module 701, and sends the maximum transmission rate to the forwarding device, so that the forwarding device controls transmitting a SDN packet to the controller according to the maximum transmission rate.

The first module 701 may acquire information of the forwarding device in the SDN which is connected with an external network and/or a terminal device, which may include the following procedures: the first module 701 acquires the information reported by the forwarding device in the SDN which is connected with an external network and/or a terminal device, wherein the information comprises a type of the forwarding device, and/or a type of a device which is connected with the forwarding device, and/or a bandwidth of a port through which the forwarding device accesses a control layer in the SDN.

The second module 702 may calculate the maximum transmission rate for the forwarding device to transmit a SDN packet to the controller according to the acquired information of the forwarding device, which may include the following procedures: according to the type of the forwarding device, and/or the type of the device which is connected with the forwarding device, and/or the bandwidth of a port through which the forwarding device accesses a control layer in the SDN, the second module 702 allocates a calculation factor for the maximum transmission rate, and according to the calculation factor and a maximum packet processing capability of the controller, calculates the maximum transmission rate for the forwarding device to transmit a SDN packet to the controller.

The second module 702 may further monitor a packet processing indicator of the controller; and discard a SDN packet sent by a forwarding device according to a pre-determined strategy when the controller determines that the packet processing indicator is beyond a pre-determined alarm value.

The packet processing indicator may comprise a CPU occupancy rate, and/or whether SDN packets overflow.

The second module 702 may discard a SDN packet sent by a forwarding device according to a pre-determined strategy, which may include the following procedures: for each forwarding device, the second module 702 calculates a SDN packet transmission rate by dividing a real-time transmission rate by a bandwidth of a port through which the forwarding device accesses a control layer in the SDN, ranks the calculated SDN packet transmission rates in a descending order, discards a packet sent by a forwarding device corresponding to the ranked SDN packet transmission rates successively, until the packet processing indicator of the controller reaches a normal value.

The first module 701 may acquire information of the forwarding device in the SDN which is connected with an external network and/or a terminal device, which may include the following procedures: the first module 701 determines a forwarding device which is connected with the terminal device according to a packet-in packet received from the forwarding device, the packet-in packet encapsulating a packet sent by the terminal device; and determines a forwarding device which is connected with the external network according to information about network deployment configured in the controller.

The first module 701 may acquire information of the forwarding device in the SDN which is connected with an external network and/or a terminal device, which may include the following procedures: the first module 701 determines a forwarding device which is connected with the terminal device according to a packet-in packet received from the forwarding device, the packet-in packet encapsulating a packet sent by the terminal device; and acquires a network topology structure between forwarding devices, and according to a port of the determined forwarding device which is connected with the terminal device, the acquired network topology structure and ports reported by a forwarding device, determines a forwarding device which is connected with the external network.

FIG. 8 is a schematic diagram illustrating a structure of a SDN controller according to an example of the present disclosure. The SDN controller may include: a processor 810, a non-transitory machine-readable storage medium 820, and a bus 830. The processor 810 and the machine-readable storage medium 820 are connected by the bus 830.

The processor 810 is configured to execute modules of machine-readable instructions stored in the machine-readable storage medium 820.

The machine-readable storage medium 820 is configured to store the machine-readable instruction modules executed by the processor 810. The modules executed by the processor 810 may include: the first module 701 and the second module 702. When executed by the processor 810, the above-described functions of the first module 701 and the second module 702 may be achieved.

In this case, the instructions read from the storage medium can implement the functions of any of the aforementioned examples, and therefore, the instructions and the machine-readable storage medium storing the instructions constitute a part of the present disclosure.

A non-transitory “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

According to the above-described examples of the present disclosure, it can be seen that by calculating a maximum transmission rate for the forwarding device to transmit a SDN packet to the controller according to the acquired information of the forwarding device, the packets transmitted from the forwarding device to the controller may be controlled, and the heavy burden may be alleviated for the SDN controller.

The foregoing is preferred examples of the present disclosure, which is not intended to limit the present disclosure. Any modifications, equivalents, and improvements made within the spirit and principle of the present disclosure should be covered by the scope of the present disclosure.

What is claimed is:

1. A method for controlling packet transmission in a Software Defined Network (SDN), comprising:
acquiring, by a controller, information of a forwarding device in the SDN which is connected with an external network and/or a terminal device;
calculating, by the controller, a maximum transmission rate for the forwarding device to transmit a SDN packet to the controller according to the acquired information of the forwarding device, and sending the maximum transmission rate to the forwarding device, so that the forwarding device controls transmitting a SDN packet to the controller according to the maximum transmission rate.

2. The method according to claim 1, wherein acquiring information of the forwarding device in the SDN which is connected with an external network and/or a terminal device comprises:
acquiring the information reported by the forwarding device in the SDN which is connected with an external network and/or a terminal device, the information comprising a type of the forwarding device, and/or a type of a device which is connected with the forwarding device, and/or a bandwidth of a port through which the forwarding device accesses a control layer in the SDN;
calculating the maximum transmission rate for the forwarding device to transmit a SDN packet to the controller according to the acquired information of the forwarding device comprising:
according to the type of the forwarding device, and/or the type of the device which is connected with the forwarding device, and/or the bandwidth of a port through which the forwarding device accesses a control layer in the SDN, allocating a calculation factor for the maximum transmission rate, and according to the calculation factor and a maximum packet processing capability of the controller, calculating the maximum transmission rate for the forwarding device to transmit a SDN packet to the controller.

3. The method according to claim 1, further comprising:
monitoring a packet processing indicator of the controller;
discarding a SDN packet sent by a forwarding device according to a pre-determined strategy when the controller determines that the packet processing indicator is beyond a pre-determined alarm value.

4. The method according to claim 3, wherein the packet processing indicator comprises a Central Processing Unit (CPU) occupancy rate, and/or whether SDN packets overflow.

5. The method according to claim 3, wherein discarding a SDN packet sent by a forwarding device according to a pre-determined strategy comprises:
for each forwarding device, calculating a SDN packet transmission rate by dividing a real-time transmission rate by a bandwidth of a port through which the forwarding device accesses a control layer in the SDN, ranking the calculated SDN packet transmission rates in a descending order, discarding a packet sent by a forwarding device corresponding to the ranked SDN packet transmission rates successively, until the packet processing indicator of the controller reaches a normal value.

6. The method according to claim 1, wherein acquiring information of a forwarding device in the SDN which is connected with an external network and/or a terminal device comprising:
determining a forwarding device which is connected with the terminal device according to a packet-in packet received from the forwarding device, the packet-in packet encapsulating a packet sent by the terminal device;
determining a forwarding device which is connected with the external network according to information about network deployment configured in the controller.

7. The method according to claim 1, wherein acquiring information of a forwarding device in the SDN which is connected with an external network and/or a terminal device comprising:
determining a forwarding device which is connected with the terminal device according to a packet-in packet received from the forwarding device, the packet-in packet encapsulating a packet sent by the terminal device;
acquiring a network topology structure between forwarding devices, and according to a port of the determined forwarding device which is connected with the terminal device, the acquired network topology structure and ports reported by a forwarding device, determining a forwarding device which is connected with the external network.

8. A Software Defined Network (SDN) controller for controlling packet transmission in a SDN, the SDN controller comprising: a processor and a non-transitory storage medium storing machine-readable instructions those are executable by the processor to:
acquire information of a forwarding device in the SDN which is connected with an external network and/or a terminal device;
calculate a maximum transmission rate for the forwarding device to transmit a SDN packet to the SDN controller according to the acquired information of the forwarding device, and send the maximum transmission rate to the forwarding device, so that the forwarding device controls transmitting a SDN packet to the SDN controller according to the maximum transmission rate.

9. The SDN controller according to claim 8, wherein the machine-readable instructions are executable by the processor to:
acquire the information reported by the forwarding device in the SDN which is connected with an external network and/or a terminal device, the information comprising a type of the forwarding device, and/or a type of a device which is connected with the forwarding device, and/or a bandwidth of a port through which the forwarding device accesses a control layer in the SDN;
according to the type of the forwarding device, and/or the type of the device which is connected with the forwarding device, and/or the bandwidth of a port through which the forwarding device accesses a control layer in the SDN, allocate a calculation factor for the maximum transmission rate, and according to the calculation factor and a maximum packet processing capability of the SDN controller, calculate the maximum transmission rate for the forwarding device to transmit a SDN packet to the SDN controller.

10. The SDN controller according to claim 8, wherein the machine-readable instructions are executable by the processor to:
monitor a packet processing indicator of the SDN controller;
discard a SDN packet sent by a forwarding device according to a pre-determined strategy when the SDN controller determines that the packet processing indicator is beyond a pre-determined alarm value.

11. The SDN controller according to claim 10, wherein the packet processing indicator comprises a Central Processing Unit (CPU) occupancy rate, and/or whether SDN packets overflow.

12. The SDN controller according to claim 10, wherein the machine-readable instructions are executable by the processor to:
for each forwarding device, calculate a SDN packet transmission rate by dividing a real-time transmission rate by a bandwidth of a port through which the forwarding device accesses a control layer in the SDN, rank the calculated SDN packet transmission rates in a descending order, discard a packet sent by a forwarding device corresponding to the ranked SDN packet transmission rates successively, until the packet processing indicator of the SDN controller reaches a normal value.

13. The SDN controller according to claim 8, wherein the machine-readable instructions are executable by the processor to:
determine a forwarding device which is connected with the terminal device according to a packet-in packet received from the forwarding device, the packet-in packet encapsulating a packet sent by the terminal device;
determine a forwarding device which is connected with the external network according to information about network deployment configured in the SDN controller.

14. The SDN controller according to claim 8, wherein the machine-readable instructions are executable by the processor to:
determine a forwarding device which is connected with the terminal device according to a packet-in packet received from the forwarding device, the packet-in packet encapsulating a packet sent by the terminal device;
acquire a network topology structure between forwarding devices, and according to a port of the determined forwarding device which is connected with the terminal device, the acquired network topology structure and ports reported by a forwarding device, determine a forwarding device which is connected with the external network.

15. A non-transitory storage medium, storing machine-readable instructions executable by a processor for controlling packet transmission in a Software Defined Network (SDN), the instructions comprising instructions to:
acquire information of a forwarding device in the SDN which is connected with an external network and/or a terminal device;
calculate a maximum transmission rate for the forwarding device to transmit a SDN packet to a controller according to the acquired information of the forwarding device, and send the maximum transmission rate to the forwarding device, so that the forwarding device controls transmitting a SDN packet to the controller according to the maximum transmission rate.
